(19) United States
(12) Patent Application Publication
(10) Pub. No.: US 2005/0010636 A1
(43) Pub. Date: Jan. 13, 2005

(54) Print control method, server and program

(75) Inventors: Iwao Nakamura, Nagano (JP); Hiroaki Mikami, Tokyo (JP); Tatsuya Ichikawa, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/628,306

(22) Filed: Jul. 29, 2003

(30) Foreign Application Priority Data
Jul. 29, 2002 (JP) P2002-219988

(51) Int. Cl. G06F 15/16

(52) U.S. Cl. 709/203

(57) ABSTRACT

A print control method using a server and a plurality of print systems that can communicate with each other through a network, the print control method includes: a print request step of transmitting to the server a print information request which requests print object data and control information for printing the print object data by the print system, in the print control system, a transmission step of transmitting the print object data and the control information to the print system when the print information request is received, in the server, and a print step of printing the print object data using the control information, in the print system.

### BACKGROUND OF THE INVENTION

1. Field of the Invention

This invention relates to print control method, server and program.

2. Related Art

As a method for distributing data such as image data, text data and so on, a method which uses WWW (World Wide Web) has been known. For example, when someone wishes to distribute image data which is recorded by a digital camera when he/she went on a trip to a plurality of friends who went on a trip together with him/her, if he/she prepares an HTML file for browsing the image data recorded and uploads it to a WWW server together with image data, and informs the friends of URL for accessing to the HTML file, each friend can browse the image data by a Web browser on the basis of the URL. Therefore, there is no necessity that a distributor (sender) of the image data distributes the image data to each individual, and it is possible to reduce trouble to a large extent. On one hand, the friend (recipient) browses the image data through the URL which is informed, and if necessary, it is possible to print the image data by for example, a printer which is connected to a personal computer.

However, since print of the distributed data is carried out by a recipient in the conventional method, even if a sender prepares and distributes data on the assumption that it is printed with a certain specific print setup, it does not necessarily means that, at the side of the recipient, it is printed out with the same setup as one that the sender assumed. For example, even if the image data is prepared on the assumption that it is printed out by setting for example, specific gray scale, resolution, paper size, correction processing and so on to a printer driver, and uploaded to the WWW server, if the recipient does not carry out the same print setup as assumed, a print result which is outputted from a printer of the recipient is to become one which is different from what the sender intended.

### SUMMARY OF THE INVENTION

This invention is one which is created for solving the above-described problem, and its object is to provide print control server, method and program by which a print result that a distributor of print object data intends is easily obtained at a place to which the print object data is distributed.

A print control method which is described in claim 1 is, in a print control method which uses a server and a plurality of print systems that can communicate with each other through a network, characterized by including a print request stage for transmitting to the server a print information request which requests print object data and control information for printing the print object data by the print system, in the print control system, a transmission stage for transmitting the print object data and the control information to the print system when the print information request is received, in the server, and a print stage for printing the print object data by use of the control information, in the print system. According to this print control method, the print control server can transmit the print object data and the control information to the print system through the network. Since the control information is information for printing the print object data by the print system which is a place to be distributed, the print system can print the print object data in accordance with the control information, and therefore, a print result according to the control information is outputted to the print system side. Accordingly, if a distributor of the print object data stores the control information in the server in such a manner that a print result intended is obtained, it is possible to have the print system side obtained the intended print result. Consequently, according to the print control method which is described in the claim 1, the print result that the distributor of the print object data intends can be easily obtained at a place to which the print object data is distributed.

A print control method which is described in claim 2 is characterized by further including a print setup transmission stage for transmitting print setup information of the print object data to the server in a distributor terminal which can communicate with the server through the network, and control information generation stage for generating the control information on the basis of the print setup information when the print setup information is received, in the server. According to this print control method, a distributor of the print object data can transmit the print setup information from the distributor terminal which is connected through the network to the print control server, and it is possible to transmit the print setup information from a remote place which is apart from the print control server, and to have the control information generated.

A print control method which is described in claim 3 is characterized by further including a screen request stage for transmitting a screen transmission request which request screen information for transmitting the print information request, in the print system, and a screen transmission stage for transmitting the screen information to the print system when the screen transmission request is received, in the server, wherein, in the print request stage, by use of the screen information, the print information request is transmitted. According to this print control method, a user of the print system can transmit the print information request by use of a screen which is displayed on the basis of the screen information.

A print control method which is described in claim 4 is characterized in that, in the screen transmission stage, the screen information for displaying information which represents an outline of the print object data is transmitted to the print system. According to this print control method, a recipient can request print to the print control server after the outline of the print object data is confirmed.

A print control method which is described in claim 5 is characterized by further including a print setup transmission stage for transmitting print setup information of the print object data to the server, in the distributor terminal which can communicate with the server through the network, and a control information generation stage for generating the control information on the basis of the print setup information when the print setup information is received, in the server. According to this print control method, a distributor of the print object data can transmit the print setup information to the print control server from the distributor terminal which is connected through the network, and it is possible to transmit the print setup information from a remote place which is apart from the print control server, and to have the control information generated.

In a print control method which is described in claim 6, it is characterized in that, in the screen transmission stage, the screen information for displaying at least a part of the print setup information is transmitted to the print system. According to this print control method, for example, when information for designating a print paper is included in the print setup information, by displaying the information, a distributor of the print object data can guide a user of the print system so as to set the paper which is designated. That is, when a work that requires manpower is included in order for a distributor of the print object data to obtain a print result which is intended, it is possible to guide the work.

A print control method which is described in claim 7 is characterized by further including an address notification stage for notifying an address for transmitting the screen transmission request to a user of the print system which is designated in advance when the print setup information is received, in the control information generation stage. According to this print control method, by designating in advance, for example, an electronic mail address of a user of the print system to whom a distributor of the print object data wishes to notify an address for transmitting the screen transmission request, it is possible to notify a fact that the print setup information is transmitted to a user of the print system by an electronic mail. By this, the distributor of the print object data can inform a user of the print system of capability of transmitting the print information request.

In addition, each function of a plurality of means which are provided with the print control server relating to this invention can be realized by arbitrary combination of a hardware resource in which a function is specified by a structure itself and a hardware resource in which a function is specified by a program. Also, each function of these plural means is not limited to one which is realized by a hardware resource in which each is physically independent from each other.

### BRIEF DESCRIPTION OF THE DRAWINGS

FIG. 1 is a sequence diagram showing a flow of processing that a print control server according to one embodiment of this invention relays print object data.

FIG. 2 is a pattern diagram representing an appearance that the print control server according to one embodiment of the invention is connected to a network.

FIG. 3 is a block diagram showing a hardware structure of the print control server according to one embodiment of the invention.

FIG. 4 is a data flow chart of a relay program that the print control server according to one embodiment of the invention has.

FIG. 5 is a view representing an appearance that the print control server according to one embodiment of the invention displayed screen information.

### DETAILED DESCRIPTION OF PREFERRED EMBODIMENTS

Hereinafter, a preferred mode of the invention will be explained on the basis of an embodiment.

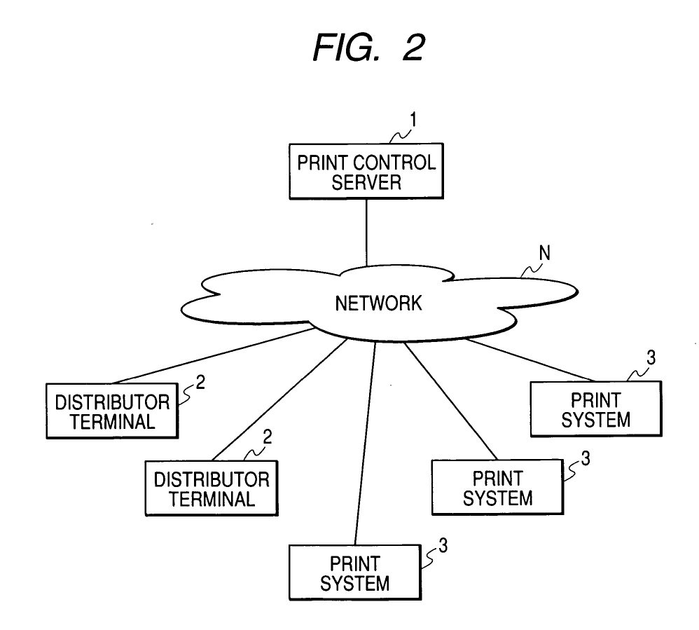

FIG. 2 is a pattern diagram representing such an appearance that a print control server 1 according to one embodiment of the invention is connected to a network N. As shown in the figure, the print control server 1 is connected through the network N such as LAN, Internet, telephone line and so on so as to be able to communicate with a plurality of distributor terminals 2 and a plurality of print systems 3 each other. The distributor terminal 2 is a personal computer, a portable telephone, a portable information terminal and so on, each of which has a Web browser and is capable of browsing an HTML file, and in this embodiment, a user of the distributor terminal 2 corresponds to a distributor of print object data. Incidentally, it may be designed that an operator of the print control server 1 has the print control server 1 stored image data, control information and so on, and in this case, the operator of the print control server 1 corresponds to the distributor of the print object data. Therefore, in this case, the distributor terminal 2 is made redundant. The print system 3, in the same manner as for example, the distributor terminal 2, is configured by a personal computer which has the Web browser and is capable of browsing the HTML file and is capable of receiving an electronic mail, and a printer which is connected to the computer.

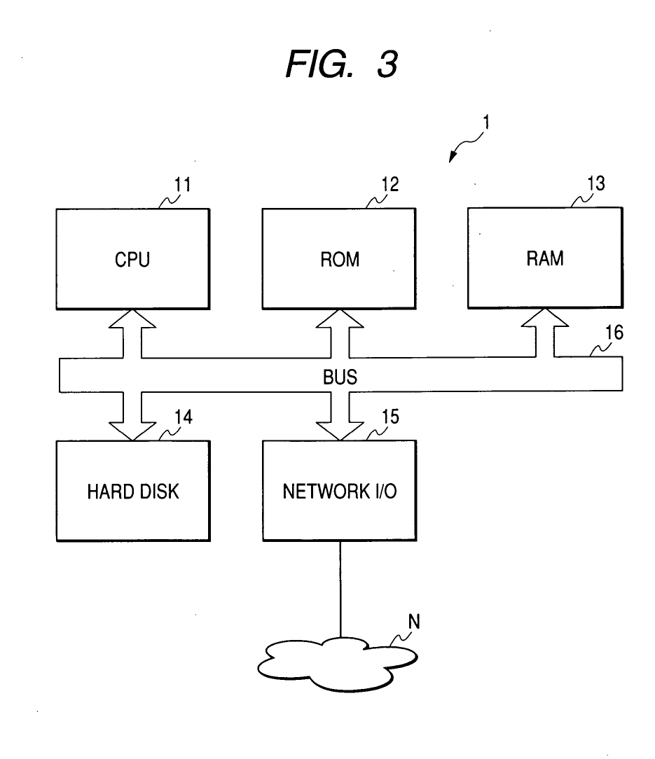

FIG. 3 is a block diagram showing a hardware structure of the print control server 1. As shown in the figure, the print control server 1 includes a CPU 11, a ROM 12, a ROM 13, a hard disk 14, a network I/O 15, and is connected to each other by a bus 16. The CPU 11 executes a program which has been stored in the ROM 12 and the hard disk 14 to control each part of the print control server 1, and in addition, executes a print relay program to carry out processing for relaying print, and so on. The ROM 12 is a memory which stores in advance a program and data which are minimum required so as for the CPU 11 to operate, and the RAM 13 is a memory which temporarily stores various programs, various data and soon. In the hard disk 14 as storage means, an operating system (OS), a setup HTML file for inputting print setup information of the print object data and an electronic mail address of a user of the print system 3, a print relay program, image data as the print object data, a thumbnail image which is prepared by thinning the number of pixels of image data which is associated with image data, and so on are stored. The stored image data is image data that a distributor of the print object data wishes to distribute, and the image data and the thumbnail image data are ones which are uploaded to the print relay server 1 by the distributor of the print object data through the use of FTP and so on. In this embodiment, information which represents an outline of the print object data corresponds to images which are displayed on the basis of the thumbnail image data. In addition, the print object data may be arbitrary data if it is data which can be printed by a printer such as text data which is prepared by a word processor, and so on. The network I/O 15 is a so-called network interface card, a modem and so on, and it is configured to be able to be connected to the network N.

Next, the print relay program will be described. The print relay program is configured by a relay program which is executed in the print control server 1, and a print program which is sent from the print control server 1 to the print system 3 as a part of the control information and executed in the print system 3.

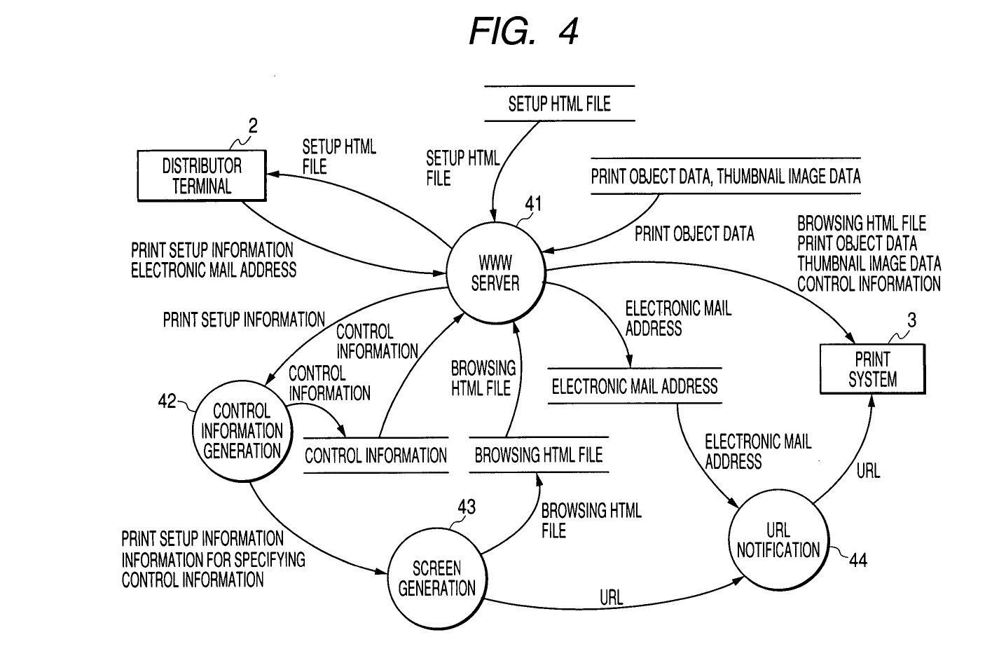

FIG. 4 is a data flow chart of the relay program. As shown in the figure, the relay program causes the print control server 1 to execute a WWW server process 41, a control information generation process 42, a screen generation process 43 and a URL notification process 44.

The WWW server process 41 is a process for operating as a WWW server, and carries out data transmission and reception with the distributor terminal 2 and the print system 3 in accordance with an HTTP protocol. The WWW server process 41 carries out processing for transmitting the setup HTML file to the distributor terminal 2, processing for receiving from the distributor terminal 2 the print setup information and electronic mail address of the print object data which have been inputted by use of the setup HTML file and for calling for the control information generation process 42 by use of the print setup information as an argument, processing for having the hard disk 14 stored the electronic mail address, processing for receiving from the print system 3 a screen transmission request which requests screen information for transmitting a print information request, and for transmitting to the print system 3 a browsing HTML file as the screen information and thumbnail image data to be displayed by the browsing HTML file, processing for receiving the print information request from the print system 3 and for transmitting image data and the control information to the print system 3, and so on. The setup HTML file is an HTML file for inputting an electronic mail address of a user of the print system 3 to which the print setup information of the print object data and URL of the browsing HTML file are desired to be notified, and information for displaying a file name input column of the print object data and an input column of the electronic mail address is described by use of HTML. The print setup information is information for generating the control information, and is inputted by a user of the distributor terminal 2 so as to obtain a print result that the user of the distributor setup information intends. The print setup information is configured by information for specifying the print object data, and setup information of a printer which prints those print object data. The “setup information for specifying the print object data” is, for example, a file name, and information for designating image data which is set as a print object out of image data which has been stored in the hard disk 14. The “setup information of a printer” is information such as gray scale to be printed, resolution, paper type, paper size, color/monochrome print, vertical/horizontal print, single side/both sides print, correction processing and so on, and information that a print program controls a printer driver of the print system 3. In addition, the “setup information of a printer” may be properly changed in response to items which can be set up to a printer driver that the print system 3 has. The browsing HTML file and the control information will be described later.

The control information generation process 42 is a process for generating the control information on the basis of the print setup information. The control signal generation process 42 carries out processing for calling out the print setup information as an argument from the WWW server process 41, for generating the control information and for having the hard disk 14 stored, processing for calling out the screen generation process 43 by use of the print setup information and information for specifying the control signal generated as arguments, and so on. The control information is information which is configured by a print program and print setup information which is converted into such a format that the print program can understand. The print program is a program which is executed by the print system 3, and controls a printer driver of a printer which is connected to the print system 3 on the basis of the print setup information which is included in the control information, and prints image data which is transmitted to the print system 3 together with the control information. By this, in the print system, it is possible to obtain a print result that a user of the distributor terminal 2 intended. The “information for specifying the control information” is information for specifying control signal with a simple heart out of a plurality of control information. Since there are a plurality of the distributor terminals 2, a plurality of control information are to be generated and stored in the hard disk 14.

The screen generation process 43 is a process for generating the browsing HTML file. The screen generation process 43 is called out from the control information generation process 42, and carries out processing for generating thumbnail image data which is associated with image data specified by the “information for specifying the print object data” of the print setup information, the browsing HTML file for displaying a part of the “setup information of a printer” of the print setup information and a “Print Execute” button for inputting an instruction for transmitting the print information request, and for having the hard disk 14 stored, processing for calling out the URL notification process 44 by use of an address for transmitting a screen transmission request to the browsing HTML file generated, i.e., URL as an argument, and so on. The screen generation process 43, when generating the browsing HTML file, fills the “information for specifying the control information” in the browsing HTML file in association with description relating to the “Print Execute” button. By this, the browsing HTML file is coordinated with the control information.

The URL notification process 44 is a process for notifying the URL of the browsing HTML file by an electronic mail, and carries out processing for transmitting an electronic mail in which the URL received is described as an argument to an electronic mail address which is stored in the hard disk 14.

In addition, in this embodiment, the print control server 1 transmits an electronic mail for notifying URL to a user of the print system 3, but the print control server 1 may transmits FAX to notify, and a user of the distributor terminal 2 may notify by an electronic mail and FAX, and may communicate by phone.

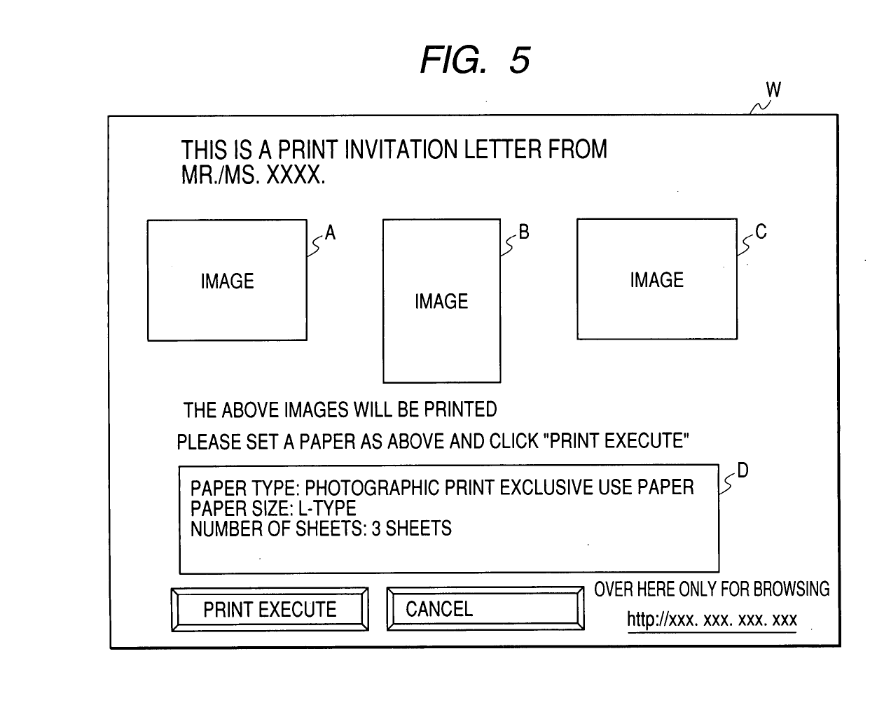

Next, the browsing HTML file W that the screen generation process 43 generates will be described. FIG. 5 is a view showing one example when the browsing HTML file W is displayed by a Web browser of the print system 3. In the example shown in the figure, images A to C are thumbnail images which are displayed on the basis of thumbnail image data which is associated with image data of a print object text information D which is displayed under the images A to C is a part of the print setup information. As described above, the “setup information of a printer” of the print setup information includes information such as gray scale, resolution, paper type, paper size, color/monochrome print, vertical/horizontal print, single side/both sides print, correction processing and so on, and in this embodiment, as a par of it, “Paper Type”, “Paper Size” are displayed. In addition, “Number of Sheets” in the figure corresponds to the number of the print object data which is specified by the “information for specifying the print object data” of the print setup information. A user refers to those print setup information which are displayed, and if in case of the example shown in the figure, a work for setting three photographic printing exclusive use papers of L-type to a printer. The “Print Execute” button is a button for instructing print of image data which is associated with the thumbnail image data which is displayed by the browsing HTML file W, and when a user clicks the “Print Execute” button by use of a mouse, the print information request is transmitted to the print control server 1.

Next, an operation that the print control server 1 relays the print will be described.

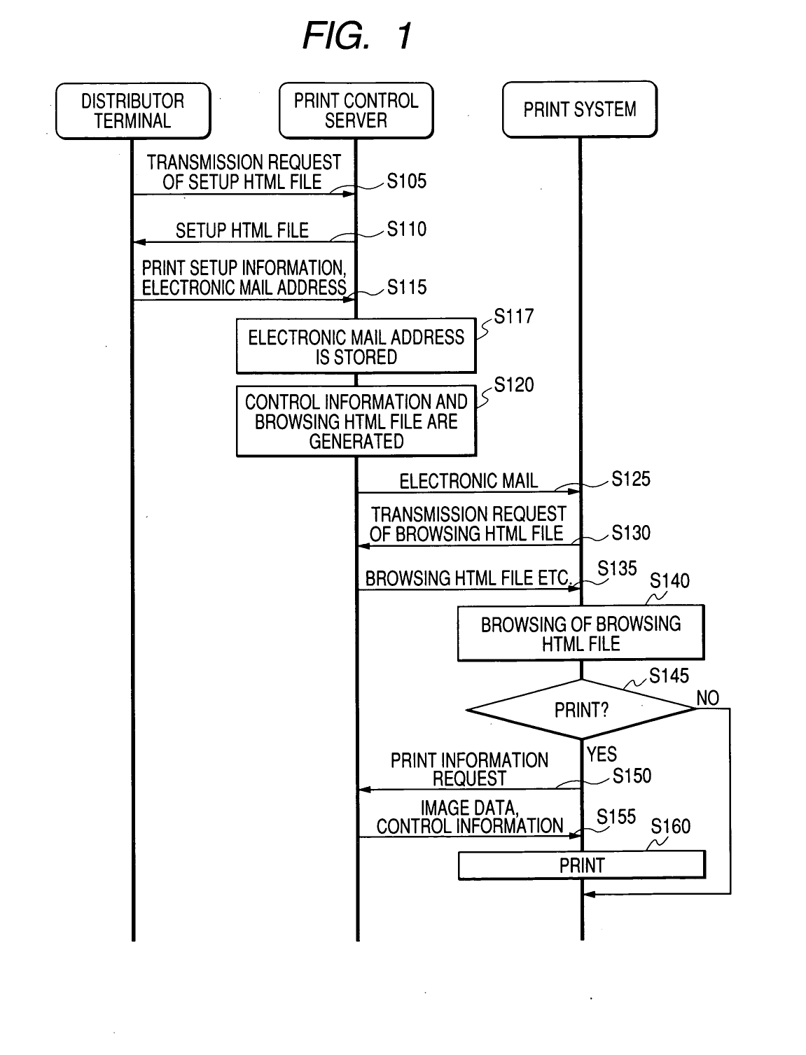

FIG. 1 is a sequence diagram showing a flow of processing that the print control server 1 relays the print. A user of the distributor terminal 2 activates the Web browser at the distributor terminal 2, and designates a predetermined URL and requests transmission of a setup HTML file (SLOS). The print control server 1, in response to the transmission request, transmits the setup HTML file to the distributor terminal 2 (S110). The distributor terminal 2 displays the received setup HTML file by use of the Web browser, and a user of the distributor terminal 2 carries out an input of an electronic mail address to which the print setup information and URL of image data are notified on a screen which displayed the setup HTML file, and instructs a transmission of the print setup information by carrying out a predetermined operation. The distributor terminal 2 transmits the inputted print setup information and electronic mail address to the print control server 1 (S115) The print control server 1 has the hard disk 14 stored the received electronic mail address (S117). Next, the control information, and the browsing HTML file W for displaying the thumbnail image data which is associated with image data that is specified by the “information for specifying the print object data” of the received print setup information and for displaying a part of the print setup information are generated (S1210), and transmits URL of the generated browsing HTML file to an electronic mail address of a user of the print system 3 which is stored in the hard disk 14 (S125).

A user of each print system 3 who received the electronic mail in the print system activates the Web browser in the print system 3, and designates URL which is notified by the electronic mail, and transmits a screen transmission request for requesting a transmission of the browsing HTML file W. In addition, a user of the print system 3 may receive an electronic mail at an other arbitrary receiving terminal than the print system 3 (S130).

The print control server 1, in response to the screen transmission request, transmits the browsing HTML file W and the thumbnail image data which is displayed by the browsing HTML file W to the print system 3 (S135), and the print system 3 displays the received browsing HTML file W by use of the Web browser. A user of the print system 3 browses the thumbnail images and the print setup information which are displayed in the Web browser (S140), and judges whether executes print or not (S145). In case that it is judged to print, the “Print Execute” button is clicked by use of a mouse to instruct execution of print. When the execution of print is instructed, the print information request including the “information for specifying the control information” which is filled in, in association with description of the “Print Execute” button is transmitted to the print control server 1 (S150). On one hand, in case that it is judged not to execute the print, subsequent steps are not executed.

Upon receiving the print information request, the print control server 1 reads out from the hard disk 14 the control information which is specified by the “information for specifying the control information”, and transmits the control information, and image data which is specified by the “information for specifying the print object data” which is included in the print setup information of the control information to the print system 3 (S155).

Upon receiving the image data and the control information, the print system 3 executes a print program which is included in the control information, and controls processing of a printer driver that the print system 3 has, in accordance with the print setup information which is included in the control information, and executes processing for having a printer which is connected to the print system 3 printed the image data (S160). By the foregoing, in the print system 3, a print result that a user of the distributor terminal 2 intended is obtained.

As above, the operation of the print control server 1 is described. In the embodiment of this invention, the “storage means” which is described in Claims is configured by the hard disk 14 and so on. The “reception means” which is described in Claims is configured by the CPU 11, the RAM 13, the network I/O 15 and so on, and its function is realized by the WWW server process 41. The “transmission means” which is described in Claims is configured by the CPU 11, the RAM 13, the network I/O 15 and so on, and its function is realized by the WWW server process 41. The “screen selection means” which is described in Claims is configured by the CPU 11, the RAM 13, the network I/O 15 and son on, and its function is realized by the WWW server process 41. The “screen transmission means” which is described in Claims is configured by the CPU 11, the RAM 13, the network I/O 15 and so on, and its function is realized by the WWW server process 41 and the screen generation process 43. The “print setup means” which is described in Claims is configured by the CPU 11, the RAM 13, the network I/O 15 and so on, and its function is realized by the WWW server process 41. The “control information generation means” which is described in Claims is configured by the CPU 11, the RAM 13 and so on, and its function is realized by the control information generation process 42. The “address notification means” which is described in Claims is configured by the CPU 11, the RAM 13, the network I/O 15 and so on, and its function is realized by the URL notification process 44.

Hereinafter, advantages of the invention will be described. According to the print control server 1 of this embodiment, the print relay server 1 transmits the control information which includes the print program and the print setup information to the print system 3 through the network N, and the print system 3 executes the print program to control processing of a printer driver on the basis of the control information, and has a printer which is connected printed the image data. Therefore, if a user of the distributor terminal 2 inputs the print setup information in such a manner that the control information for obtaining a print result which is intended is generated, it is possible to have the print system 3 obtained the print result that a user of the distributor terminal 2 intends. Consequently, according to the print control server 1 of the embodiment, the print result that a user of the distributor terminal 2 intends is easily obtained by the print system 3.

In addition, in this embodiment, the control information includes the print program, but it may be designed that it does not includes the print program but includes only the print setup information. In this case, it may be designed that the print program is distributed separately to the print system by use of any other means, and the print system 3 receives the control information which includes only the print setup information, and prints out by a print program which is separately distributed in accordance with the received control information. By this, a necessity of distributing the print program each time is eliminated.

Also, in this embodiment, a case which is configured by the print relay server, the distributor terminal 2 and the print system 3 is described by way of example, but this invention may be applied to a case which is configured by the print relay server 1 and the print system 3. That is, it is not a case that a distributor of the print object data transmits the print setup information and electronic mail address and so on to the print relay server 1 by use of the distributor terminal 2, but those information may be stored in the hard disk 14 by directly operating the print relay server 1.

Also, in the embodiment, the browsing HTML file W , i.e., the screen information is used in order to transmit the print information request, but, without using the screen information, the print information request may be transmitted by inputting URL which corresponds to the print information request to the Web browser. In this case, it may be designed that, together with the image data and the control information, an HTML file which is different from the browsing HTML file is transmitted in addition, and the image data is displayed by the different HTML file. Also, in this case, it may be designed that when the “Print Execute” button of the different HTML file is clicked, print of the image data which has already been transmitted is started by the print program which is included in the control information which has already been transmitted.

Also, in the browsing HTML file of this embodiment, as information which represents an outline of the image data, thumbnail images on the basis of the thumbnail image data are displayed, but a descriptive text for describing the outline of the image data may be displayed.

Also, the print system 3 of this embodiment requests the image data and the control information by one print information request, but the image data and the control information may be requested by separate print information requests. For example, at first, a print data request for requesting the image data may be transmitted, and thereafter, a print control information request for requesting the control information may be transmitted.

1-22. (canceled)

23. A print control method using a server and a plurality of print systems that can communicate with each other through a network, the print control method comprising:
a print request step of transmitting to the server a print information request which requests print object data and control information for printing the print object data by the print system, in the print control system,
a transmission step of transmitting the print object data and the control information to the print system when the print information request is received, in the server, and
a print step of printing the print object data using the control information, in the print system.

24. The print control method according to claim 23 further comprising:
a print setup transmission step of transmitting print setup information of the print object data to the server in a distributor terminal which can communicate with the server through the network, and
a control information generation step of generating the control information on the basis of the print setup information when the print setup information is received, in the server.

25. The print control method according to claim 23 further comprising:
a screen request step of transmitting a screen transmission request which request screen information for transmitting the print information request, in the print system, and
a screen transmission step of transmitting the screen information to the print system when the screen transmission request is received, in the server,
wherein, in the print request stage, the print information request is transmitted by using the screen information.

26. The print control method according to claim 25, wherein in the screen transmission stage, the screen information for displaying information which represents an outline of the print object data is transmitted to the print system.

27. The print control method according to claim 25 further comprising:
a print setup transmission step of transmitting print setup information of the print object data to the server, in the distributor terminal which can communicate with the server through the network, and
a control information generation step of generating the control information on the basis of the print setup information when the print setup information is received, in the server.

28. The print control method according to claim 27, wherein in the screen transmission stage, the screen information for displaying at least a part of the print setup information is transmitted to the print system.

29. The print control method according to claim 27 further comprising an address notification step of notifying an address for transmitting the screen transmission request to a user of the print system which is designated in advance when the print setup information is received, in the control information generation step.

30. A print control server comprising:
a storage unit that stores print object data and control information for printing the print object data by a print system,
a reception unit that receives a print information request which requests the print object data and the control information from the print system through a network, and
a transmission unit that transmits the print object data and the control information to the print system through the network when the print information request is received.

31. The print control server according to claim 30 further comprising:
a print setup unit that receives print setup information of the print object data through the network, and
a control information generation unit that generates the control information on the basis of the print setup information.

32. The print control server according to claim 30 further comprising:
a screen selection unit that receives a screen transmission request which requests screen information for transmitting the print control request from the print system through the network, and
a screen transmission unit that transmits the screen information to the print system through the network when the screen transmission request is received.

33. The print control server according to claim 32, wherein the screen transmission unit transmits the screen information for displaying information which represents an outline of the print object data to the print system.

34. The print control server according to claim 32 further comprising:
a print setup unit that receives print setup information of the print object data through the network, and
a control information generation unit that generates the control information on the basis of the print setup information.

35. The print control server according to claim 34, wherein the screen transmission unit transmits the screen information for displaying at least a part of the print setup information to the print system.

36. The print control server according to claim 34 further comprising an address notification unit that notifies an address for transmitting the screen transmission request to a user of the print system which is designated in advance when the print setup unit receives the print setup information.

37. A computer readable recording medium storing a print control program causing a computer to execute:
a reception step of receiving a print information request from a print system through a network, the print information request requesting print object data and control information for printing the print object data by a print system, and
a transmission step of transmitting the print object data and the control information to the print system through the network when the print information request is received.

38. The computer readable recording medium according to claim 37, wherein the program causes the computer to further execute:
a print setup step of receiving print setup information of the print object data through the network, and
a control information generation step of generating the control information on the basis of the print setup information.

39. The computer readable recording medium according to claim 37, wherein the program causes the computer to further execute:
a screen selection step of receiving a screen transmission request which requests screen information for transmitting the print information request from the print system through the network, and
a screen transmission step of transmitting the screen information to the print system through the network in response to the screen transmission request.

40. The computer readable recording medium according to claim 39, wherein the screen transmission step transmits the screen information for displaying information which represents an outline of the print object data to the print system.

41. The computer readable recording medium according to claim 39, wherein the program causes the computer to further execute:
a print setup step of receiving print setup information of the print object data through the network, and
a control information generation step of generating the control information on the basis of the print setup information.

42. The computer readable recording medium according to claim 41, wherein the screen transmission step transmits the screen information for displaying at least a part of the print setup information to the print system.

43. The computer readable recording medium according to claim 41, wherein the program causes the computer to further execute an address notification step of notifying an address for transmitting the screen transmission request to a user of the print system which is designated in advance when the print setup information is received in the print setup procedure.
